(19) United States
(12) Patent Application Publication
(10) Pub. No.: US 2018/0229067 A1
(43) Pub. Date: Aug. 16, 2018

(54) EXERCISE DEVICES FOR USERS IN CONFINED SPACE

(71) Applicant: Eric Michael Smith, Los Angeles, CA (US)

(72) Inventor: Eric Michael Smith, Los Angeles, CA (US)

(21) Appl. No.: 15/830,491

(22) Filed: Dec. 4, 2017

Related U.S. Application Data
(60) Provisional application No. 62/549,905, filed on Aug. 24, 2017.
(60) Provisional application No. 62/473,003, filed on Mar. 17, 2017.
(60) Provisional application No. 62/457,686, filed on Feb. 10, 2017.

(51) Int. Cl. A63B 21/04; A63B 21/055; A63B 21/00; A63B 21/16; A63B 23/04; B64D 11/06

(52) U.S. Cl. CPC A63B 21/04; A63B 21/0557; A63B 21/4034; A63B 2022/0097; A63B 21/4043; A63B 23/0405; B64D 11/0607; A63B 21/1609

(57) ABSTRACT

An exercise device includes an elastic cable, a panel, and a spindle coupled to an interior side of the panel. The spindle has a locked state and an unlocked state, the spindle being rotatable in a first direction to wind the elastic cable and being rotatable in a second direction to unwind both ends of the elastic cable when the spindle is in the unlocked state, and the spindle being non-rotatable when the spindle is in the locked state. A first stirrup is coupled to a first end of the elastic cable, and a second stirrup is coupled to a second end of the elastic cable.

### CROSS-REFERENCE TO RELATED APPLICATIONS

The present application claims the benefit of U.S. Provisional Patent Application Ser. No. 62/549,905 filed Aug. 24, 2017 and entitled “Exercise Equipment in Confined Space,” U.S. Provisional Patent Application Ser. No. 62/473,003 filed Mar. 17, 2017 and entitled “System and Methods for Exercise,” and U.S. Provisional Patent Application Ser. No. 62/457,686 filed Feb. 10, 2017 and entitled “System and Methods for Exercise,” which are hereby incorporated by reference herein.

### TECHNICAL FIELD

This disclosure pertains to exercise devices. More particular, this disclosure pertains to exercise devices for users in confined space.

### BACKGROUND

Prolonged periods of sitting without sufficient leg movement may lead to serious health issues. For example, blood stasis may be caused by limited leg movement, which may lead to blood clots. In the human body, pumping of the heart allows blood to flow through arteries, while one-way valves and gravity moves blood through veins. A lack of body movement may cause blood to pool in veins, which is also known as venous stasis, which can be detrimental for human health, decrease adequate perfusion, and is a factor in developing deep vein thrombosis (DVT). For these reasons, it may be necessary to move body parts as much as possible to prevent a lack of blood flow in the human body.

Movement of the human body is often limited when people are seated in a confined space, such as passenger seats of a vehicle. In addition, there may be physical and/or subconscious hindrances preventing users from leaving their seats to walk around. For example, on an airplane, especially in coach class regions, passengers have insufficient physical space, safety concerns, desire not to hinder crew members and other passengers, and/or desire not to disturb other passengers seated on neighboring seats.

### SUMMARY

In various embodiments, an exercise device includes an elastic cable, a panel, and a spindle coupled to an interior side of the panel. The spindle has a locked state and an unlocked state, the spindle being rotatable in a first direction to wind the elastic cable and being rotatable in a second direction to unwind both ends of the elastic cable when the spindle is in the unlocked state, and the spindle being non-rotatable when the spindle is in the locked state. A first stirrup is coupled to a first end of the elastic cable, and a second stirrup is coupled to a second end of the elastic cable.

In some embodiments, the exercise devices further comprises a handle configured to rotate the spindle. In related embodiments, the handle is further configured to place the spindle in the unlocked state or the locked state.

In some embodiments, the first stirrup comprises a first hinge configured to bias the first stirrup toward a folded position. In related embodiments, the second stirrup comprises a second hinge configured to bias the second stirrup toward a folded position.

In some embodiments, the exercise device includes an attachment mechanism for attaching the exercise device to a first chair for use by a user in a second chair positioned behind the first chair. In related embodiments, the exercise device is attached to the lower portion of a back of a backrest portion of the first chair.

In some embodiments, the first and second chairs are mounted on an transportation vehicle.

In some embodiments, the first and second chairs are mounted on array-type seating area.

In various embodiments, a chair comprises a chair body on which an occupant can be seated, and an exercise device coupled to the seat body at a position such that a user seated behind the chair is capable of performing exercise using the exercise device. The exercise device includes an elastic cable and a spindle around which the elastic cable is at least partially wound, the spindle having a locked state and an unlocked state, the spindle being rotatable in a first direction of winding the elastic cable and in a second direction of unwinding the elastic cable when the spindle is in the unlocked state, and non-rotatable when the spindle is in the locked state. The exercise device includes a first stirrup coupled to a first end of the elastic cable, and a second stirrup coupled to a second end of the elastic cable.

In some embodiments, the chair body includes a seat portion on which the occupant's lower body is accommodatable and a backrest portion, and at least a portion of the exercise device is mounted flush with a surface of the seat portion.

In some embodiments, the chair body includes a seat portion on which the occupant's lower body is accommodatable and a backrest portion, and at least a portion of the exercise device is mounted flush with a back surface of the backrest portion.

In some embodiments, the chair body includes an armrest and an armrest frame configured to support the armrest, and the exercise device is coupled to the armrest frame.

In some embodiments, the chair body includes a seat portion on which the occupant's lower body is accommodatable and a backrest portion, and at least a portion of the exercise device is fit in a recess formed in at least one of the seat portion and the backrest portion.

In some embodiments, the chair body includes a seat portion on which the occupant's lower body is accommodatable, a backrest portion, and a pocket disposed on a back surface of the backrest portion, and the exercise device is disposed at a position below the pocket.

In various embodiments, a transportation vehicle comprises a passenger area that includes an array of seats for passengers, the array of seats includes a first chair and a second chair that is immediately behind the first chair, the first chair including a chair body on which a first passenger can be seated, and an exercise device coupled to the chair body at a position such that a second passenger seated on the second chair is capable of performing exercise using the exercise device. The exercise device includes a cable, a spindle around which the elastic cable is at least partially wound, the spindle including a locked position and an unlocked position, the spindle being rotatable in a first direction of winding the elastic cable and in a second direction of unwinding the elastic cable when the spindle is in the unlocked state, and non-rotatable when the spindle is in the locked state. The exercise device further includes a first stirrup coupled to a first end of the elastic cable, and a second stirrup coupled to a second end of the elastic cable.

In some embodiments, the transportation vehicle is an aerial vehicle, and the passenger area has a denser seat pattern than another one of the plurality of passenger areas.

In some embodiments, the second chair is one of a plurality of seats in a row and farthest from an aisle of the passenger area among the plurality of seats in the row.

In some embodiments, the passenger area further includes a non-chair structure immediately in front of the first chair, and the non-chair structure includes a second exercise device at a position such that the first passenger seated on the first chair is capable of performing exercise using the second exercise device.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 is a schematic diagram depicting a side view of an example chair having attached thereon an exercise device that includes an elastic exercise device according to some embodiments.

FIG. 2A and FIG. 2B are schematic diagrams depicting an example transparent view of an elastic exercise device according to some embodiments.

FIG. 2C is a schematic diagram depicting an example transparent view of an elastic exercise device in an example “in-use” position according to some embodiments.

FIG. 3 is a flowchart of an example of a method for operating an elastic exercise device according to some embodiments.

FIG. 4 is a schematic diagram depicting an example of an array of chairs, including one or more chairs each having an elastic exercise device, in a passenger area of a transportation vehicle such as an airplane according to some embodiments.

FIG. 5 is a schematic diagram depicting an example use of an elastic exercise device according to some embodiments.

### DETAILED DESCRIPTION

Various embodiments described herein are directed to exercise devices capable of being used in confined (e.g., limited) spaces, chairs having mounted thereon exercise devices capable of being used in confined space, and transportation vehicles including chairs having mounted thereon exercise devices capable of being used in confined space. Example transportation vehicles include land-based vehicles (e.g., automobiles, trains, buses, and/or the like) and/or off-land vehicles (e.g., airplanes, ships, and/or the like).

Various embodiments are directed to providing an exercise device that is usable in confined space. According to some embodiments, an exercise device may comprise an elastic cable, a panel, a spindle coupled to an interior side of the panel, and a lockable handle. When the spindle is in an unlocked state, using the lockable handle, the spindle is rotatable in a first direction to wind the elastic cable around it, thus shortening the elastic cable available and increasing cable tension for the user. When the spindle is in an unlocked state, using the lockable handle, the spindle is rotatable in a second direction to unwind the elastic cable from around it, thus lengthening the elastic cable available and decreasing cable tension for the user. When the spindle is in a locked state, the spindle is non-rotatable. In some embodiments, a first stirrup is coupled to a first end of the elastic cable, and a second stirrup is coupled to a second end of the elastic cable. In some embodiments, the passenger can place his feet into the stirrups to exercise, e.g., by performing leg press movement. In some embodiments, the user can grip the stirrups with his hands to perform arm exercises, such as curls.

In some embodiments, the exercise devices address the health issues of concern due to excessive sitting in confined space, while dealing with one or more of technical issues related to size, weight, safety, appearance, and/or suitability in a transportation vehicle. An exercise device according to some embodiments can be made sufficiently small (especially shallow) to avoid interfering with ingress or egress from the vehicle, e.g., from the aisle seats on an airplane. For example, because the exercise device is quite shallow, e.g., it will not interfere with a passenger trying to evacuate a window, middle or aisle seat. An exercise device according to some embodiments can be sufficiently light to be mounted on a transportation vehicle in which weight is particularly important. Furthermore, an exercise device according to some embodiments can be unobtrusive (e.g., “blend”) in an interior environment of a transportation vehicle.

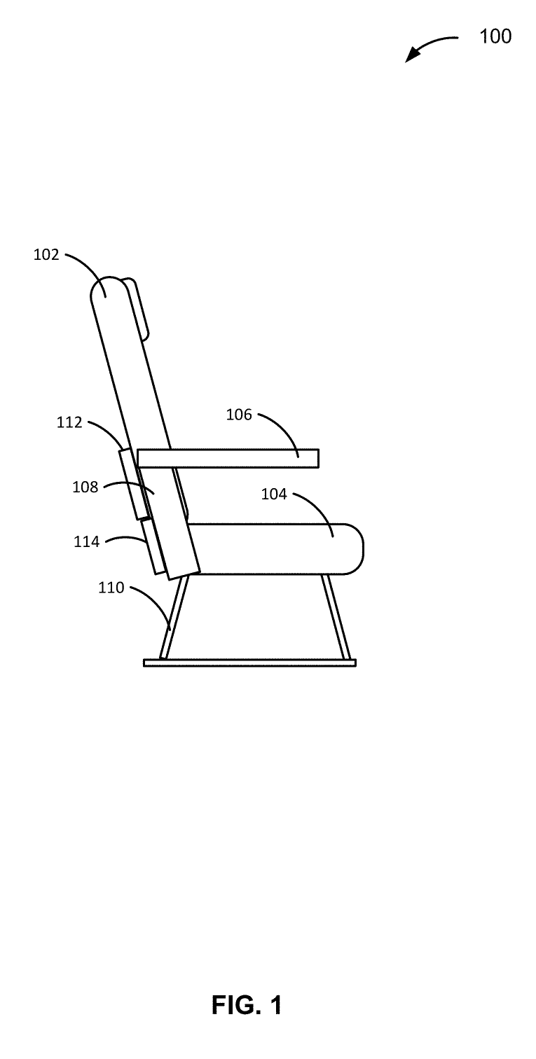

FIG. 1 is a schematic diagram depicting an example side view of a chair 100 that includes mounted thereon an elastic exercise device according to some embodiments. In the example depicted in FIG. 1, the chair 100 includes a backrest 102, a seat 104, an armrest 106, an armrest support frame 108, chair support frame 110, a pocket 112, and an exercise device 114. In the example depicted in FIG. 1, the exercise device 114 mounted on the chair 100 provides exercise opportunity to a person seated behind the chair 100. In some embodiments, the chair 100 is provided in a public transportation vehicle such as an airplane, a bus, a train, a ship, and so on, and non-public transportation vehicles such as passenger vehicles, private airplanes, and so forth. In some embodiments, the chair 100 is provided in a non-transportation venue, such as theaters, stadiums, classrooms, sports arenas, offices, and other array-type seating. The exercise device 114 works well whenever there is an array of seats.

In the example depicted in FIG. 1, the backrest 102 represents a back support member that supports at least some of the weight of an occupant. In some embodiments, the backrest 102 includes one or more of three different parts of different heights: lower backrest; shoulder height backrest; and headrest. The lower back backrest may supports only a lumbar region of the occupant. The shoulder height backrest may support the middle back and shoulders of the occupant. The headrest may support the head of the occupant, and may be important in vehicles for preventing “whiplash” neck injuries in rear-end collisions where the head is jerked back suddenly. In some embodiments, the backrest 102 is configured to provide reclining function.

In the example depicted in FIG. 1, the seat 104 is intended to represent a bottom portion support member that supports a significant portion of the weight of an occupant. In some embodiments, the seat 104 is coupled to the backrest 102, and/or supports the backrest 102 itself.

In the example depicted in FIG. 1, each armrest 106 is intended to represent a support member for the arms, when the arms rest on the armrests. In some embodiments, the armrest 106 is provided on one or both sides (e.g., left and right sides) of the backrest 102. In some embodiments, each armrest 106 is configured to be movable (e.g., rotatable) between a use position that is substantially parallel with the seat 104 and a non-use position that is substantially flush with a side of the backrest 102. Movement of the armrest 106 may be configured to make entry and exit from the chair 100 easier.

In the example depicted in FIG. 1, the armrest support frame 108 is a frame member coupled to the armrest 106 that supports at least the armrest 106. In some embodiments, the armrest support frame 108 is provided on one or both sides (e.g., left and right sides) of the backrest 102. In some embodiments, the armrest support frame 108 is coupled to one or both of the backrest 102 and the seat 104.

In the example depicted in FIG. 1, the chair support frame 110 is a frame member that supports the chair 100 and is mountable to the floor. In some embodiments, the support frame 110 supports the seat 104 (including front and rear portions and left and right sides). In some embodiments, the chair support frame 110 is coupled to one or both of the backrest 102 and the armrest support frame 108.

In the example depicted in FIG. 1, the pocket 112 is intended to represent a pouch or container for a person seated behind the support frame 110. In some embodiments, the pocket 112 is coupled to one or more of the backrest 102, the armrest 106, and the armrest support frame 108.

In the example depicted in FIG. 1, the elastic exercise device 114 is positioned on the backside of the chair 100 in front of the passenger who has access to use it. The passenger can use the exercise device attached to the chair 100 in front of him/her to exercise. In some embodiments, the exercise device 114 is attached to a surface of the back of the backrest 102 of the chair 100. For example, the exercise device 114 may be attached to an outer surface (e.g., rear surface) of the backrest 102 below the pocket 112. Advantageously, since a space below the pocket 112 is typically unused space, the exercise device 114 can efficiently take advantage of the unused space for valuable exercise purposes. Further, in a case where the chair 100 is on an airplane, the exercise device 114 provided on the backrest 102 would not interfere with use of space below the seat 104, for example, for an emergency kit (e.g., flotation devices, oxygen masks). It will not be significantly affected when the chair 100 reclines, since the lower portion of the chair 100 does not move much when the chair reclines. Advantageously, regardless of variable reclining positions of the backrest 102, if any, the exercise device 114 can be conveniently positioned for exercise. In another example, the exercise device 114 may be attached to an outer surface (e.g., bottom surface) of the seat 104.

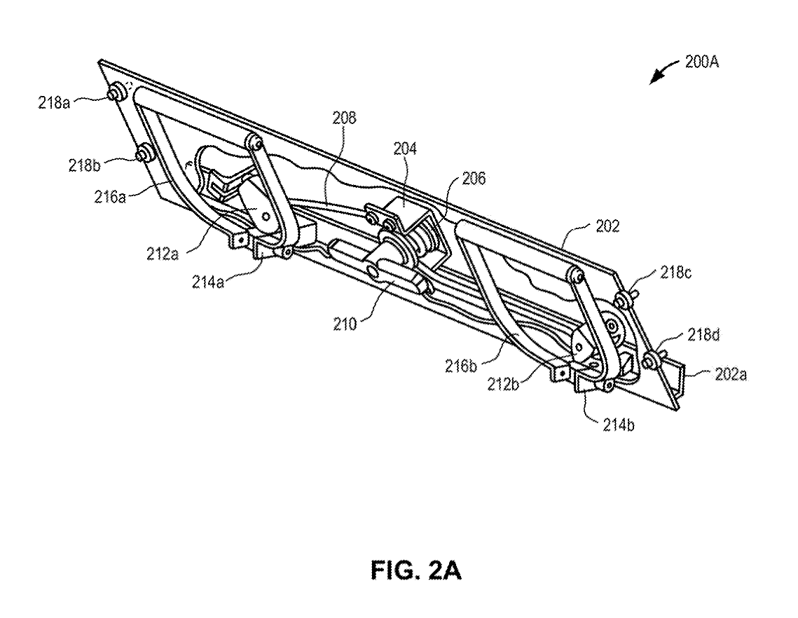

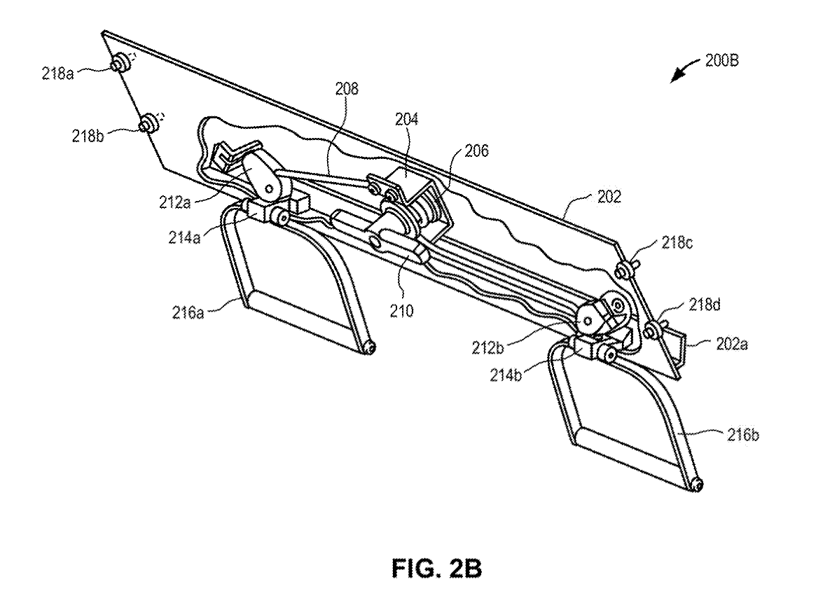

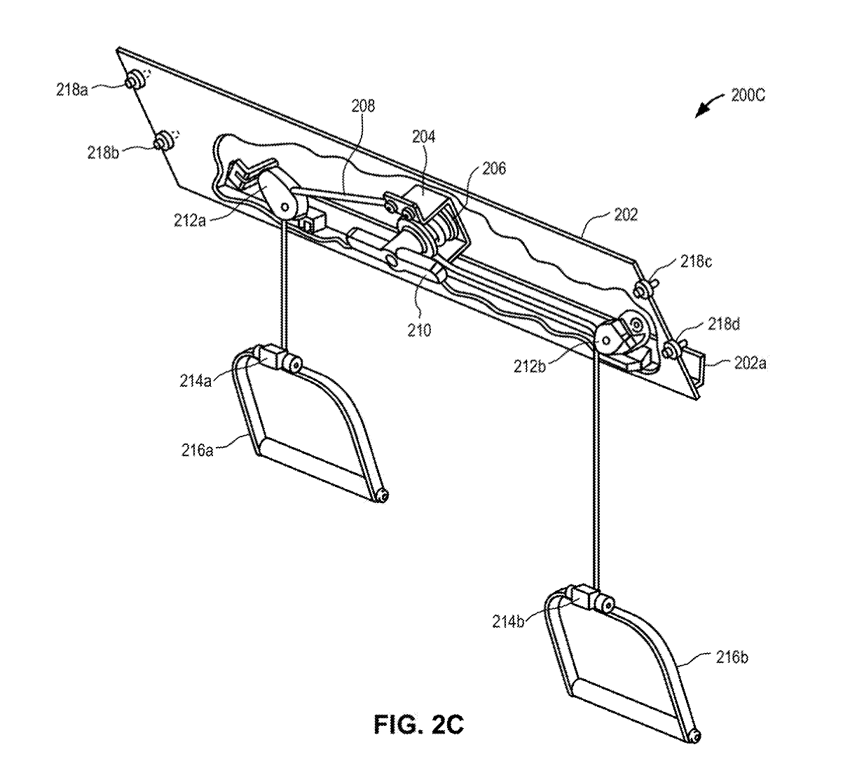

In some embodiments, at least a portion of the exercise device 114 is embedded in a recessed space formed in the backrest 102 and/or the seat 104. For example, a protrusion (e.g., a spindle attachment 204 and/or a pulley 212 in FIG. 2) of the exercise device 114 that protrudes towards the backrest 102 and/or the seat 104 may be fit within a recess formed in the backrest 102 and/or the seat 104. In another example, a member (e.g., an elastic cable 208) of the exercise device 114 may pass through an internal space of the backrest 102 and/or the seat 104. To the extent of the embedded portion of the exercise device 114, a portion of the chair 100 can be removed.

In some embodiments, the exercise device 114 is coupled to one or more members of the chair 100. For example, the exercise device 114 may be coupled to the armrest support frame 108. This coupling of the elastic exercise device 114 to the armrest support frame 108 may be suitable for reasons of sufficient strength of the coupling and/or efficient space usage. For example, the exercise device 114 may be mechanically coupled to the one or more members of the chair 100 using one or more hardware devices such as fasteners (e.g., bolts, nuts, rivets, screws, washers, nails, etc.). In another example, the exercise device 114 may be coupled to the one or more members of the chair 100 using adhesive materials. In still another example, the exercise device 114 may be electromagnetically coupled to the one or more members of the chair 100.

In some embodiments, the exercise device 114 may be formed of inflammable materials when the chair 100 is used for fuel-based transportation. The exercise device 114 may be formed of light-weight materials (e.g., less than 820 grams in total) so as not to excessively affect fuel efficiency. The depth of the exercise device 114 may be designed to protrude from the chair no more than 0.25″, 0.5″, 1″ and/or other limited depth so as not interfere with safety and/or other requirements of the associated transportation vehicle. In some embodiments, the exercise device 114 is recessed entirely within the back of the chair 100 and does not protrude from the chair 100 at all.

FIG. 2A and FIG. 2B (hereinafter collectively referred to as FIG. 2) are schematic diagrams depicting a transparent view of an example exercise device according to some embodiments. FIG. 2A depicts a transparent view 200A of the exercise device in a stored state, and FIG. 2B depicts a transparent view 200B of the example exercise device in a use state. In the example depicted in FIG. 2, the exercise device includes a trim panel 202, a spindle attachment 204, a spindle 206, an elastic cable 208, a handle 210, pulleys 212a and 212b, hinges 214a and 214b, stirrups 216a and 216b, and fasteners 218a-218d. In the example depicted in FIG. 2, the exercise device is a device configured to provide exercise opportunity to a seated user. In some embodiments, the exercise device corresponds to the exercise device 114 in FIG. 1, and thus is included in or attached to a chair in front of a chair of the seated user. In some embodiments, the exercise device is included in or attached to a non-chair structure of a transportation vehicle that is positionable in front of a chair of the seated user. For example, the non-chair structure includes a wall/partition structure inside a transportation vehicle, a luggage container, underneath the dash of an automobile, built into a glovebox of an automobile, and/or the like.

In the example depicted in FIG. 2, the trim panel 202 is a member configured to separate internal mechanical portion of the elastic exercise device and an external user interactive portion of the elastic exercise device. In some embodiments, as shown in FIG. 2, the trim panel 202 has a rectangular shape longitudinal in a transverse direction and includes a transverse folded-back portion 202a configured to ensure clearance on the side of the internal mechanical portion 202a. The trim panel 202 may also have a secondary panel attached thereto, which may prevent the internal components of the exercise device from making contact with the chair, or other device, it is mounted to. Although the trim panel 202 is shown as having a flat shape, the trim panel 202 may have also comprise other shapes instead of, or in addition to, a flat shape. For example, the trim panel 202 may be curved (e.g., for mounting to chairs in a lecture hall) and/or other shape capable of being mounted to the base structures described herein. In some embodiments, the transverse folded-back portion 202a has at least two openings through which the elastic cable 208 extends from the internal mechanical portion of the elastic exercise device to the user interactive portion of the elastic exercise device. In some embodiments, as shown in FIG. 2, the trim panel 202 includes one or more structures (e.g., holes) to accommodate members (e.g., the fasteners 218a-218d) to fix the elastic exercise device to a base structure (e.g., a chair) at applicable position(s) such as both ends of the transverse direction of the trim panel 202. The trim panel 202 may be formed of light-weight metal (e.g., aluminum) and/or light-weight synthetic materials (e.g., polycarbonate, carbon fiber, plastics, etc.). In some embodiments, the trim panel 202 may have dimensions suitable for mounting on the base structures described herein. For example, the trim panel 202 may have a length of 20 inches, a height of 5 inches, and/or a depth less than 0.25 inches. Similarly, the overall dimensions of the exercise device may be 20 inches in length, 5 inches in height, and/or 0.25 inches in depth.

In some embodiments, the exercise device may include a back panel. This may, for example, provide improved mounting characteristics and/or prevent the elastic cable 208 from rubbing against the chair, which may adversely affect the person seated in front of the user.

In the example depicted in FIG. 2, the spindle attachment 204 is a member for accommodating the spindle 206, such that the spindle 206 can rotate around its rotational axis when the spindle 206 is in a rotatable (or, “unlocked”) state, and cannot rotate around its rotational axis when the spindle 206 is in a non-rotatable (or, “locked”) state. In some embodiments, as shown in FIG. 2, the spindle attachment 204 forms a space (e.g., a box-shaped space) in which the spindle 206 can be accommodated. The spindle attachment 204 is coupled to an applicable member to fix position of the spindle attachment 204. For example, as shown in FIG. 2, the spindle attachment 204 is coupled to the trim panel 202. In another example, the spindle attachment 204 may be coupled to the base structure (e.g., a chair, a secondary panel, and/or the like). In some embodiments, as shown in FIG. 2, the spindle attachment 204 includes one or more structures (e.g., holes) to accommodate members (e.g., the fasteners 218a-218d) to fix the spindle attachment 204 to the applicable member such as both ends of the transverse direction of the trim panel 202. The spindle attachment 204 may be formed of light-weight metal (e.g., aluminum) and/or light-weight synthetic materials (e.g., polycarbonate, carbon fiber, plastics, etc.). In some embodiments, the spindle attachment 204 has dimension(s) sufficient to receive the spindle 206. For example, the spindle attachment 204 may have a height of 2 inches (e.g., the body of the spindle attachment 205 having a height of 1.5 inches, and each of the screw plates of the spindle attachment 204 having a height of 0.25 inches.). The spindle attachment 204 may have a length of 1.5 inches and/or a depth of 1 inch.

In the example depicted in FIG. 2, the spindle 206 is intended to represent a rotatable member around or through which the elastic cable 208 can be wound. In some embodiments, the elastic cable 208 is attached to and/or wound around and/or through the spindle 206 such that rotation of the spindle 206 in a rotational direction (e.g., a first rotational direction) causes lengths of both loose ends of the elastic cable 208 (i.e., not wound around the spindle 206) to increase, and such that rotation of the spindle 206 in an opposite rotational direction (e.g., a second rotational direction) causes the lengths of both loose ends of the elastic cable 208 to decrease. To achieve this configuration, the shaft and/or the rotatable portion of the spindle 206 may have a hollow structure through which the elastic cable 208 passes. In some embodiments, a shaft (e.g., rod) of the spindle 206 is coupled to the spindle attachment 204 and a rotatable portion (e.g., rotor) of the spindle 206 is coupled to the shaft via bearing. In some embodiments, the spindle 206 is configured to automatically roll up the elastic cable 208 when a stopper (not shown in FIG. 2) of the spindle 206 to stop the roll-up is released (unlocked). The stopper is configured to lock rotation of the spindle 206. The spindle 206 may be formed of light-weight metal (e.g., aluminum) and/or light-weight synthetic materials (e.g., polycarbonate, carbon fiber, plastics, etc.). In some embodiments, the spindle 206 has dimensions sufficient to be received by the spindle attachment 204. For example, the spindle 206 may have a diameter less than 1 inch and/or a depth of less than 1 inch.

In the example depicted in FIG. 2, the elastic cable 208 is a string-shaped member configured to provide resistance for exercise. At least part of the elastic cable 208 is attached to and/or wound around and/or through the spindle 206. When one end of the elastic cable 208 receives a drawing force, the elastic cable 208 is configured to stretch with a resistance relative to the available length. The number of windings around the spindle 206 will affect the length and thus will affect the elastic resistance. Accordingly, different resistances can be provided. The elastic cable 208 is formed of elastic materials, such as bungee cord. Further, multiple elastic cables of different lengths and/or different resistances (e.g., width, roughness) may be provided such that a user can use one of the elastic cables suitable for an intended purpose. Accordingly, the elastic cable 208 may comprise various characteristics (e.g., length, cross-sectional diameter, resistance values, and/or the like). For example, the elastic cable 208 may have a resistance of between 4 and 14 pounds. The resistance value may be based on how much the spindle 206 is rotated. The elastic cable 208 may extend 12 inches within the trim panel 202. The distance between the two pinned stirrups 216 (e.g., in non-twisted setting) may be 14 inches.

In the example depicted in FIG. 2, the handle 210 is a rotatable member configured to enable a user to rotate the spindle 206. In some embodiments, the handle 210 is coupled to a shaft of the spindle 206 or serves as a shaft of the spindle 206. In some embodiments, the handle 210 can be positioned at an engaged position at which the handle 210 is engaged with the spindle 206 (specifically, the rotor of the spindle 206), and at a disengaged position at which the handle 210 is not engaged with the spindle 206. For example, when the handle 210 is engaged with the spindle 206, rotation of the handle 210 causes rotation of the spindle 206; and when the handle 210 is not engaged with the spindle 206, rotation of the handle 210 is restricted or rotation of the handle 210 does not cause rotation of the spindle 206. In some embodiments, when the handle 210 can be positioned at the engaged position and the disengaged position, the engaged position is at a position more outward than the disengaged position. For example, a user can place the handle 210 at the engaged position by pulling out the handle 210, and can place the handle 210 at the disengaged position by pushing down the handle 210. The handle 210 may be formed of light-weight metal (e.g., aluminum) and/or light-weight synthetic materials (e.g., polycarbonate, carbon fiber, plastics, etc.).

In the example depicted in FIG. 2, the pulleys 212a and 212b are rotatable members along which both ends of the elastic cable 208 move. The pulleys 212a and 212b are provided on both sides (e.g., left and right) of the spindle 206 respectively and configured to redirect the elastic cable 208 to the direction of the movement of the body parts of the user. In some embodiments, the pulleys 212a and 212b are coupled to the trim panel 202 with an applicable mechanism for coupling (e.g., fasteners). In some embodiments, rotors of the pulleys 212a and 212b rotate when the elastic cable 208 moves with drawing forces, such that the pulleys 212a and 212b provide little to no resistance against the drawing forces. Depending on a specific implementation, the pulleys 212a and 212b may be formed of light-weight metal (e.g., aluminum) and/or light-weight synthetic materials (e.g., polycarbonate, carbon fiber, plastics, etc.). Further, the number of pulleys may not be limited to two.

In the example depicted in FIG. 2, the hinges 214a and 214b are intended to represent members with which the stirrups 216a and 216b rotate, respectively. The hinges 214a and 214b are provided in correspondence with the pulleys 212a and 212b and coupled to both ends of the elastic cable 208, respectively. The hinges 214a and 214b may be part of the stirrups 216a and 216b, respectively, or may be provided separately from the stirrups 216a and 216b, respectively. In some embodiments, one or more of the hinges 214a and 214b have a tapered hole and a tapered plug that has a tapered shape matching the tapered shape of the tapered hole and is configured to be inserted and pressed against the tapered hole, and one or both ends of the elastic cable 208 are compressed between the tapered hole and the tapered plug. In some embodiments, a coupling position of one or both of the hinges 214a and 214b with the elastic cable 208 is adjustable, such that an effective length of the elastic cable 208 for exercise can be changed.

In some embodiments, as shown in FIG. 2A, at least part of the hinges 214a and 214b are accommodated in a recess formed by the transverse folded-back portion 202a and the trim panel 202 when the exercise device is in the stored state. In some embodiments, as shown in FIG. 2A, one or both of the hinges 214a and 214b are configured to rotationally bias the stirrups 216a and 216b upward such that the stirrups 216a and 216b are flush with the trim panel 202 when the elastic exercise device is in the stored state. To apply the biasing force, a mechanism such as a spring can be employed. In some embodiments, as shown in FIG. 2B, one or both of the hinges 214a and 214b are configured to disable the biasing force or lock rotation of the stirrups 216a and 216b around the hinges 214a and 214b at a predetermined position when the elastic exercise device is in the use state. To disable the biasing force or lock rotation of the stirrups 216a and 216b, a mechanism such as a spring-loaded plunger can be employed. The hinges 214a and 214b may be formed of light-weight metal (e.g., aluminum) and/or light-weight synthetic materials (e.g., polycarbonate, carbon fiber, plastics, etc.). Further, the number of hinges may not be limited to two. In some embodiments, there may be only one.

In the example depicted in FIG. 2, the stirrups 216a and 216b are members to be coupled to body parts of a user. The stirrups 216a and 216b are coupled to the hinges 214a and 214b, respectively, in an applicable manner. In some embodiments, the body parts may be left and right feet of the user, left and right hands of the user, and so on. For example, when a user places the user's left and right feet, in some embodiments, the user can place the left foot on a straight bar portion of the stirrup 216a and the right foot on a straight bar portion of the stirrup 216b. In another example, when a user places the user's left and right hands, in some embodiments, the user can grab the straight bar portion of the stirrup 216a with the left hand and the straight bar portion of the stirrup 216b with the right hand. In some embodiments, one or more clips (not shown in FIG. 2) may be provided on the outside of the trim panel 202 to keep the one or both of the stirrups 216a and 216b in place when one or both of the stirrups 216a and 216b are at the stored position. The one or more clips are configured to be coupled to one or both of the stirrups 216a and 216b when one or both of the stirrups 216a and 216b are at the stored position, so as to restrict movement of the one or both of the stirrups 216a and 216b. The stirrups 216a and 216b may be formed of light-weight metal (e.g., aluminum) and/or light-weight synthetic materials (e.g., polycarbonate, carbon fiber, plastics, etc.).

In the example depicted in FIG. 2, the fasteners 218a-218d are intended to represent members to fix the elastic exercise device to an applicable base structure (e.g., a chair). In some embodiments, as shown in FIG. 2, the fasteners 218a-218d are coupled to the trim panel 202. In some embodiments, the fasteners 218a-218d are one or more of bolts, nuts, rivets, screws, washers, nails. The fasteners 218a-218d may be formed of light-weight metal (e.g., aluminum) and/or light-weight synthetic materials (e.g., polycarbonate, carbon fiber, plastics, etc.). Further, the number of fasteners may not be limited to four.

FIG. 2C is a schematic diagram 200 depicting an example transparent view of an elastic exercise device in an example “in-use” position according to some embodiments.

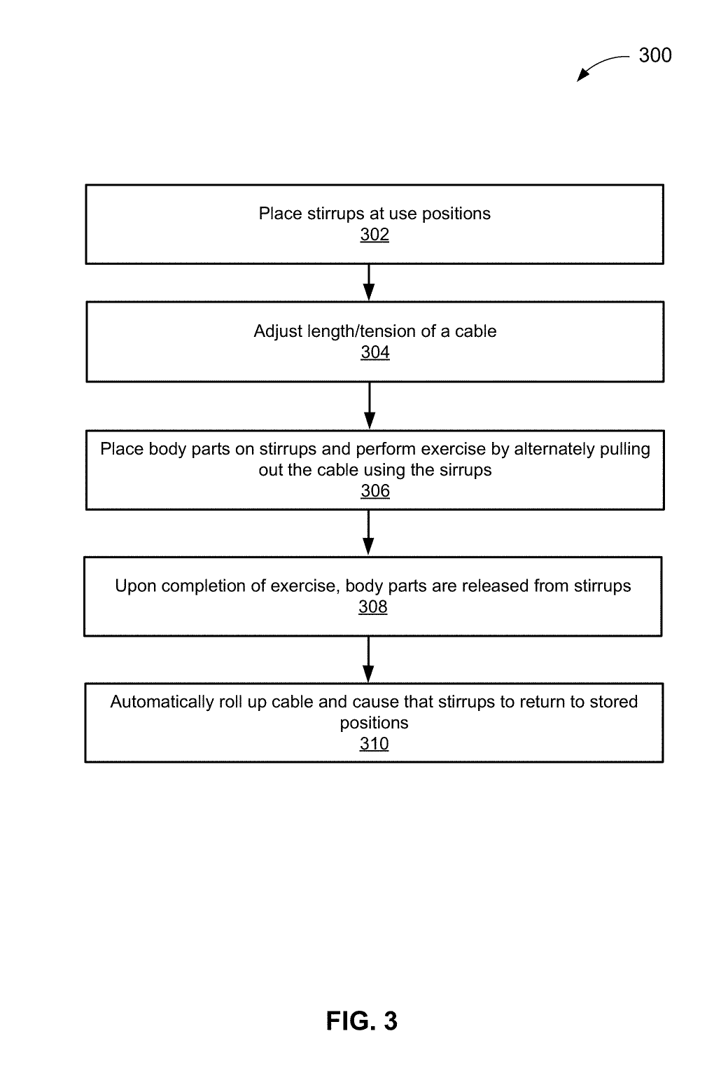

FIG. 3 is a flowchart 300 of an example of a method for operating an exercise device according to some embodiments. In some embodiments, the exercise device operated in the method corresponds to the exercise device 114 in FIG. 1 and/or the elastic exercise device in FIG. 2. It should be recognized that the modules can be reorganized for parallel execution, reordered, modified (changed, removed, or augmented), where circumstances permit.

In the example of FIG. 3, the flowchart 300 starts at module 302, where stirrups of an elastic exercise device are placed at use positions. In some embodiments, the stirrups of the elastic exercise device correspond to the stirrups 216a and 216b of the elastic exercise device depicted in FIG. 2A and FIG. 2B, and the use positions are positions of the stirrups 216a and 216b in the use state depicted in FIG. 2B. Depending on a specific implementation of the embodiments, the stirrups may be manually placed at the use positions by a user or automatically placed at the use positions by a mechanical or electrical configuration of the elastic exercise device.

In the example of FIG. 3, the flowchart 300 continues to module 304, where a length and/or tension of an elastic cable is adjusted. In some embodiments, the elastic cable corresponds to the elastic cable 208 in FIG. 2. Depending on a specific implementation of the embodiments, the length and/or tension of the elastic cable may be manually adjusted by a user or automatically adjusted positions by a mechanical or electrical configuration of the elastic exercise device. When the length and/or tension of the elastic cable is manually adjusted by a user, the user can pull a handle (e.g., the handle 210 in FIG. 2) from a disengaged position to an engaged position, to adjust the length and/or tension of the elastic cable. After the handle is set at the engaged position, the user can rotate the handle in one rotational direction to increase the length and/or tension of the elastic cable, and in the other rotational direction to decrease the length and/or tension of the elastic cable. Further, after the length and/or tension of the elastic cable is adjusted to a preferred length and/or tension, the user can push the handle to the disengaged position.

In the example of FIG. 3, the flowchart 300 continues to module 306, where body parts of a user are laced on stirrups of the elastic exercise device and exercise is performed using the elastic exercise device, for example, by alternately stretching the left and right ends of the elastic cable. In some embodiments, the stirrups correspond to the stirrups 216a and 216b in FIG. 2. In some embodiments, the body parts are left and right feet of the user, and the user alternately steps down the stirrups such that the elastic cable are alternately pulled. Depending on a specific implementation of the embodiments, various exercises can be performed using the elastic exercise device. Such exercises can include leg press, stepping, ankle/calf pumping, crossed leg movements, arm curls and extensions, and so on. Also, depending on a specific implementation of the embodiments, the exercise can be performed for applicable length of time, with applicable frequency, and with applicable resistance for different purposes. For example, the exercise may be performed for 3-5 minutes each hour to maintain blood flow in the body. In another example, the exercise may performed with an increased resistance to achieve muscle training effect. In still another example, the exercise may performed for a prolonged time period with less resistance to achieve cardio exercise effect.

In the example of FIG. 3, the flowchart 300 continues to module 308, where body parts of the user are released from stirrups. In the example of FIG. 3, the flowchart 300 continues to module 310, where the ends of the elastic cable of the elastic exercise device automatically retract, and the stirrups of the elastic exercise device automatically return to original positions (e.g., stored positions). In some embodiments, the automatic return of the stirrups is caused by a spring loaded plunger provided in hinges (e.g., the hinges 214a and 214b in FIG. 2) coupled to the stirrups. In some embodiments, rubber stoppers may be provided to prevent the exercise device from snapping (e.g., if the stirrups are released). Rubber stoppers may also decrease noise and prevent the elastic cable from fraying. Additionally, in some embodiments, guided tubing may be used to assist with the elastic cable returning to the proper positioning (e.g., a starting position).

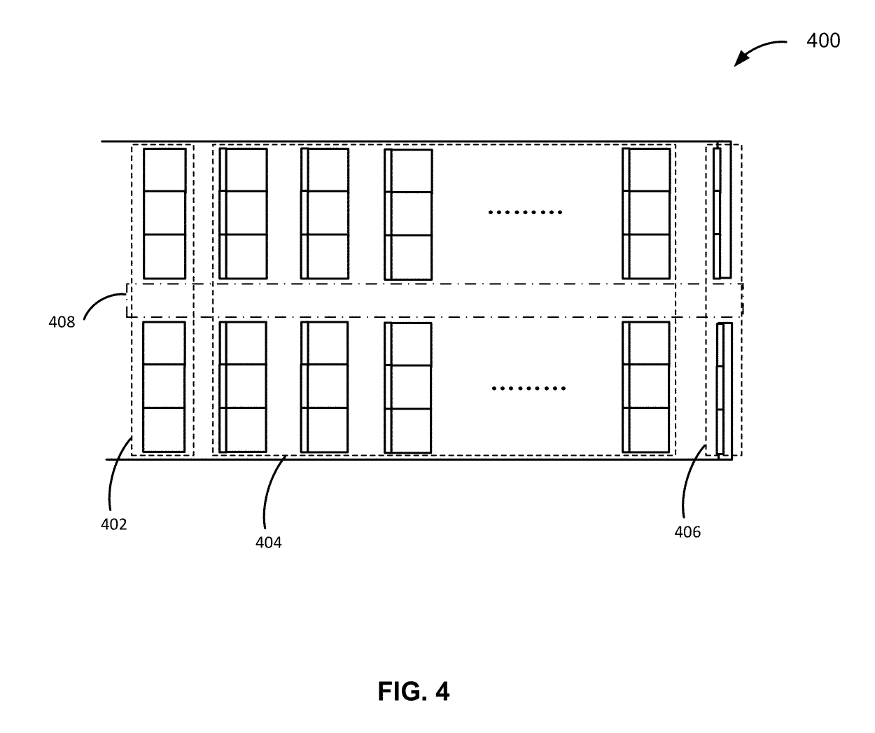

FIG. 4 is a schematic diagram depicting an example arrangement 400 of an array of seats including one or more seats having an exercise device in a confined space according to some embodiments. In the example depicted in FIG. 4, the arrangement 400 includes a group of chairs 402 in a row, a group of seats 404 in one or more rows, a group of partition walls 406, and an aisle 408 formed in the groups of chairs 402 and 404. In the example depicted in FIG. 4, a left side may be a tail end of a transportation vehicle and the right side may be a front end of the transportation vehicle. In some embodiments, individuals face the same direction when seated. Also, the top and bottom sides are boundaries of the confined space. In some embodiments, the boundaries may be formed by a body (e.g., frame, windows, etc.) of the transportation vehicle. In some embodiments, the elastic exercise device corresponds to the elastic exercise device discussed with reference to one or more of FIGS. 1-3.

In the example depicted in FIG. 4, the group of chairs 402 represents chairs without any chairs behind. The group of chairs 402 do not have an elastic exercise device because no individual is seated behind the chairs 402. In the example depicted in FIG. 4, the group of seats 404 represents chairs with chairs behind. Since individuals are seated behind the chairs 404, one or more of the chairs 404 are equipped with an elastic exercise device for individuals therebehind. In the example depicted in FIG. 4, the group of partition walls 406 is intended to represent a partition that separates one area from another area of the confined space. In some embodiments, the area is a coach class (economy class) area, and said another area is a class higher than the coach class, such as business class and first class. In some other embodiments, the confined area is for a highest passenger class, and said another area is a crew area such as cockpit. The group of partition walls 406 is equipped with one or more elastic exercise devices for individuals behind the partition walls 406. In the example depicted in FIG. 4, the aisle 408 is formed through the group of chairs 402, the group of chairs 404, and the group of partition walls 406. An applicable manner of separation of the group of chairs 402, the group of chairs 404, and the group of partition walls 406 by the aisle 408 can be employed. For example, equal or different number of seats may be positioned on both sides of the aisle 408 in each row. Also, the number of aisles may not be limited to one, and two or more aisles may be formed. In some embodiments, for non-array seating, such as being mounted on a wall, the exercise device may be pulled forward, so it is angled downward. The exercise device may be returned to the flush position when not in use. A knob (e.g., a knob similar to the knob of tray table) may keep the exercise device upright.

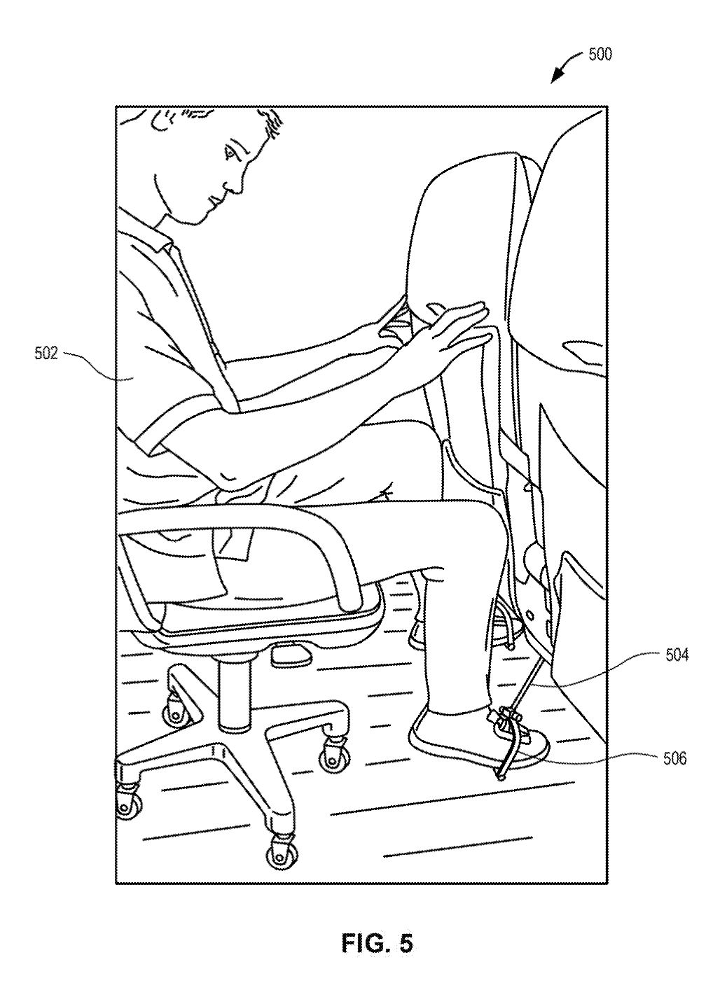

FIG. 5 is a schematic diagram 500 depicting an example use of an elastic exercise device according to some embodiments. More specifically, the diagram 500 depicts a user 502 using an elastic exercise device having an elastic cable 504 and a stirrup 506.

In the foregoing description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “some embodiments” or “various embodiments” means that a particular feature, structure or characteristic described in connection with the embodiment is included in at least one embodiment of the present invention. Thus, the appearances of the phrases “in one embodiment” or “in some embodiments” in various places throughout this specification are not necessarily all referring to the same embodiment, but may be in some instances. Furthermore, the particular features, structures, or characteristics may be combined in any suitable manner in one or more embodiments.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. An exercise device comprising:
an elastic cable;
a panel;
a spindle coupled to an interior side of the panel, the spindle having a locked state and an unlocked state, the spindle being rotatable in a first direction to wind the elastic cable and being rotatable in a second direction to unwind both ends of the elastic cable when the spindle is in the unlocked state, and the spindle being non-rotatable when the spindle is in the locked state;
a first stirrup coupled to a first end of the elastic cable; and
a second stirrup coupled to a second end of the elastic cable.

2. The exercise device of claim 1, further comprising a handle configured to rotate the spindle.

3. The exercise device of claim 2, wherein the handle is further configured to place the spindle in the unlocked state or the locked state.

4. The exercise device of claim 1, wherein the first stirrup comprises a first hinge configured to bias the first stirrup toward a folded position.

5. The exercise device of claim 4, wherein the second stirrup comprises a second hinge configured to bias the second stirrup toward a folded position.

6. The exercise device of claim 1, wherein the exercise device includes an attachment mechanism for attaching the exercise device to a first chair for use by a user in a second chair positioned behind the first chair.

7. The exercise device of claim 6, wherein the exercise device is attached to a lower portion of a back of a backrest portion of the first chair.

8. The exercise device of claim 7, wherein the first and second chairs are mounted on a transportation vehicle.

9. The exercise device of claim 7, wherein the first and second chairs are mounted on an array-type seating area.

10. A chair comprising a chair body on which an occupant can be seated, and an exercise device coupled to the chair body at a position such that a user seated behind the chair is capable of performing exercise using the exercise device, wherein the exercise device includes:
an elastic cable;
a spindle around which the elastic cable is at least partially wound, the spindle having a locked state and an unlocked state, the spindle being rotatable in a first direction of winding the elastic cable and in a second direction of unwinding the elastic cable when the spindle is in the unlocked state, and non-rotatable when the spindle is in the locked state;
a first stirrup coupled to a first end of the elastic cable; and
a second stirrup coupled to a second end of the elastic cable.

11. The chair of claim 10, wherein the chair body includes a seat portion on which the occupant's lower body is accommodatable and a backrest portion, and at least a portion of the exercise device is mounted flush with a surface of the seat portion.

12. The chair of claim 10, wherein the chair body includes a seat portion on which the occupant's lower body is accommodatable and a backrest portion, and at least a portion of the exercise device is mounted flush with a back surface of the backrest portion.

13. The chair of claim 10, wherein the chair body includes an armrest and an armrest frame configured to support the armrest, and the exercise device is coupled to the armrest frame.

14. The chair of claim 10, wherein the chair body includes a seat portion on which the occupant's lower body is accommodatable and a backrest portion, and at least a portion of the exercise device is fit in a recess formed in at least one of the seat portion and the backrest portion.

15. The chair of claim 10, wherein the chair body includes a seat portion on which the occupant's lower body is accommodatable, a backrest portion, and a pocket disposed on a back surface of the backrest portion, and the exercise device is disposed at a position below the pocket.

16. A transportation vehicle comprising a passenger area that includes an array of seats for passengers, the array of seats includes a first chair and a second chair that is immediately behind the first chair, the first chair including a chair body on which a first passenger can be seated, and an exercise device coupled to the chair body at a position such that a second passenger seated on the second chair is capable of performing exercise using the exercise device, wherein the exercise device includes:
an elastic cable;
a spindle around which the elastic cable is at least partially wound, the spindle including a locked position and an unlocked position, the spindle being rotatable in a first direction of winding the elastic cable and in a second direction of unwinding the elastic cable when the spindle is in the unlocked state, and non-rotatable when the spindle is in the locked state;
a first stirrup coupled to a first end of the elastic cable; and
a second stirrup coupled to a second end of the elastic cable.

17. The transportation vehicle of claim 16, wherein the transportation vehicle is an aerial vehicle, and the passenger area has a denser seat pattern than another one of a plurality of passenger areas.

18. The transportation vehicle of claim 16, wherein the second chair is one of a plurality of seats in a row and is farthest from an aisle of the passenger area among the plurality of seats in the row.

19. The transportation vehicle of claim 16, wherein the passenger area further includes a non-chair structure immediately in front of the first chair, and the non-chair structure includes a second exercise device at a position such that the first passenger seated on the first chair is capable of performing exercise using the second exercise device.
